(19) United States
(12) Patent Application Publication
(10) Pub. No.: US 2019/0338664 A1
(43) Pub. Date: Nov. 7, 2019

(54) Ram-jet and turbo-jet detonation engine

(71) Applicant: Dmitry Dmitrievich KOZHEVNIKOV, Schelkovo (RU)

(72) Inventor: Dmitry Dmitrievich KOZHEVNIKOV, Schelkovo (RU)

(21) Appl. No.: 16/470,822

(22) PCT Filed: Dec. 4, 2017
(86) PCT No.: PCT/RU17/00892

§ 371 Date: Jul. 22, 2019

(30) Foreign Application Priority Data
Dec. 21, 2016 (RU) 2016150493

(51) Int. Cl. F01D 15/10; F02K 7/02; F02K 1/78; F02K 7/16

(52) U.S. Cl. CPC F01D 15/10; F02K 7/02; F05D 2220/80; F02K 7/16; F02K 1/78

(57) ABSTRACT

A ram-jet and turbo-jet detonation engine includes an inlet part and a discharge part both shaped as axis-symmetrical round hollow rotating cones interconnected by a narrow middle part, having vanes, mounted on the internal surfaces of the cones, not completely overlapping a central part of a channel, and form spirals, twisted about a common central axis of the channel. The inlet cone with vanes serves as a ventilator/compressor, and the discharge cone with vanes serves as a turbine and discharge nozzle. The middle part and the discharge cone are built as one integral component. A centripetal pump supplies fuel to a mixing section. The engine includes a firing system, generating short high-voltage electrical pulses, providing for burning of combustible mixture in a detonation mode. The invention enables an independent horizontal take-off of flying apparatus and a possibility of varying/alternating the speed within a range from subsonic to hypersonic.

### CROSS-REFERENCE TO RELATED APPLICATIONS

This application is a U.S. national stage application of a PCT application PCT/RU2017/000892 filed on 4 Dec. 2017, published as WO2018117904, whose disclosure is incorporated herein in its entirety by reference, which PCT application claims priority of a Russian Federation patent application RU2016150493 filed on 21 Dec. 2016.

### FIELD OF THE INVENTION

This invention belongs to flight-type engines, specifically to supersonic jet engines.

### BACKGROUND OF THE INVENTION

Turbojet engines (TJE) are used for flying apparatus (FA) velocity range from zero to low supersonic Mach 2-3 velocities. For velocity range from low supersonic to velocity up to 5 Mach, ramjets are used. When Mach number is more than 5, hypersonic ramjets with straight channel and direct-flow combustion chamber are required.

For a long flight in dense layers of atmosphere at low subsonic velocities rocket engines are useless, as they are inefficient (uneconomic).

### Prior Art

Turbojet engines comprise rotating central body—a rotor with a compressor and turbine blades attached on the side of a central axis. Airstream (approach flow) decelerates extensively reflecting compressor blades. After turbine blades airstream can't (fails to) reach velocity rates, that are essential to accelerate flying apparatus up to high supersonic velocity.

Compressor/turbine blades reflecting airflow and mounted from the inside to the outer side of the hull, are fixed (do not rotate) as the outer hull itself.

A ramjet without blades works effectively after the flying apparatus reaches supersonic velocity. A ramjet can be designed with or without a central body. As a ramjet can't start working at a zero velocity, other engines (for example, starting solid rocket boosters) or launch aircraft (carriers) are used to accelerate flying apparatus with ramjet up to supersonic velocity without a turbojet engine. But starting launchers or launch flying apparatus are used only once at the initial flight stage. Combination and cooperation of different types of engines (hybrid engines) are possible.

Particularly, the following related art sources describe basics of design of such flying apparatus:
V. N. Novikov, B. M. Avhimovich, V. E. Vejtin 1991. Basics of structure and construction of flying apparatus. Textbook. M.: Mechanical engineering, p. 115-165.
V. M. Akimov, V. I. Bakulev, R. I. Kursiner, V. V. Poljakov, V. A. Sosunov, C. M. Shljachtenko 1987. Textbook. 2-nd edition, revised and updated. M.: Mechanical engineering.
https://ru.wikipedia.org/wiki/ [symbol] - [symbol] [symbol] .

For strategic reconnaissance aircraft SR-71 Blackbird (USA), the Pratt&Whitney J58 hybrid turbojet/ramjet engine was built. At a velocity up to 2,4 Mach it ran as an augmented turbojet, but, at higher velocities, channels opened, through which air from the inlet entered the thrust augment avoiding the compressor, the combustion chamber and the turbine; as a result, fuel supply increased and it started running as a ramjet. Such operation scheme allowed to broaden the velocity range of effective engine operation up to 3,2 Mach. The mentioned engine comprises a central body with an axial compressor and a turbine, and six special channels for airflow redirection. In the ramjet-mode, the thrust augment operates as a combustion chamber. It's impossible to reach a greater velocity because of the engine and the geometry of airflow redirecting channels, i.e. airflow direction. See for example:
http://www.airwar.ru/enc/engines/j58.html
htts://www.google.com/patents/US3344606?hlu&dq=3344606
https://www.google.com/patents/US3477455?hl=ru&dq=3477455

The majority of hybrid engines, that are able to run at a velocity ratio from zero up to supersonics has no (or a small) direct straight-flow channel, and airflow deviates from rectilinear motion, which is why it's impossible to reach hypersonic velocities with such engines.

Detonation jets, including jets with annular detonation combustion, have potential for running at a velocity range from subsonic up to supersonic velocities. See for example: http://istina.msu su/media/publications/article/070/aa6/10902423/Detonatsionnyie_reaktivnyie_dvigateli._Chast_I-_termodinamicheskij_tsikl.pdf—Detonation jets. Part I. Thermodynamic cycle. Konstantin Nikolaevich Volkov, Faculty of Science, Engineering and Computing, Kingston University, London, UK, Pavel Viktorovich Bulat, ITMO University.

### OBJECT AND SUMMARY OF THE INVENTION

The object of the present invention is designing an air-breathing engine/air-breathing turbojet engine for flying apparatus, that is able to produce thrust at zero velocity (by horizontal launch) of flying apparatus and effectively run continuously with shifts in range from subsonic velocity up to hypersonic velocities. This inventive engine is herein further called ‘Ram-jet and turbo-jet detonation engine’ (RTDE).

According to the present invention, in order to run in the hypersonic range the inventive engine should be equipped with a straight channel including a direct-flow combustion chamber. For the velocity range from zero up to low supersonics, a turbojet engine is required, which turbojet engine should have a fan (that provides additional thrust) and a compressor to pump air to the next combustion chamber located behind it, and further to a turbine rotating the fan and the compressor. The turbojet engine should also be equipped with an outlet nozzle.

The above stated object is achieved by specific design combinations of direct direct-flow channels with an air inlet, a fan/compressor, an air-fuel mixing chamber, a combustion chamber, a turbine and an outlet nozzle.

### Essential Features of the Invention

The inventive engine comprises: narrow sections attached together by a gear box on a single axis through a narrow middle section, or otherwise, or formed as an integral part, two axisymmetric round hollow rotating tapered parts with blades, mounted on the inner surface of cones, not completely overlapping the channel (the channel's central part is free), and forming spirals, twisted around the channel's common central axis.

The spinning direction of inlet cone spirals is performed so, that when rotating, front parts of the spirals could catch air in front of the cone and elevate it depthward the channel (like the Archimedean spiral but without rigid-body axis).

Blades-spirals of the inlet cone and the exhaust section, rotating in the same direction, are also twisted in one direction.

If the cones are attached to each other with a gear box or through electric coupling, their twisting direction can be opposite, and in this case twisting of their spirals will be also opposite (in the direction of the flow).

The basis of RTDE's input part operation, at subsonic velocities, is the operating principle of the jet pump with an annular nozzle and a mixer unit, having a higher velocity entraining flow (gas, fluid) as working body that embraces and entrains less rapid entrained medium (gas, fluid). See for example:
http://chem21.info/info/1445843/ Chemist's guide 21. Annular nozzles.
http://ej.kubagro.ru/2012/01/pdf/46.pdf—RECOMMENDATIONS FOR CHOOSING THE OPTIMUM GEOMETRIC SIZES OF ANNULAR NOZZLES OF JET PUMPS WITH TWO-SURFACE WORKING JET FLOWS. Reunov N. V., Efimov D. S., Taracyanz S. A. Scientific magazine of KubSAU, No. 275(01), 2012.

In the present invention, the role of the less rapid entrained medium plays the airstream attacking the flying apparatus, flowing in the center of the engine's round straight channel (without a central body), while the higher velocity (annual) entraining flow is formed at the input on the perimeter of the flow by rotation of blades-spirals on the walls, which performs a function of a centrifugal blower/compressor.

A flow section is the de Laval nozzle with blades-spirals on the walls. The exhaust section is made in the form of output nozzle.

By arranging a rotational flow in the turbojet engine with a de Laval nozzle, the flow, which has a subsonic velocity at the intake, can reach a supersonic velocity at a critical point (in the narrowest place). See for example:
MATHEMATICAL MODELING AND PARAMETRIC INVESTIGATION OF THE FLOW OF WORKING BODY'S CURVED TURBULENT ONE-COMPONENT STREAM IN TRANS AND SUPERSONIC AREAS OF THE DE LAVAL NOZZLES. V. V. Ryzhkov, I. I. Morozov.—Reporter of Samara State Aerospace University, No. 23(19), 2009, pages 382-391.

At a pre-sonic velocity of the flying apparatus, the inlet cone's blades-spirals carry out three following functions:
create a centrifugal force, which presses air contained within the inlet cone to its walls, at the same time a high pressure area is being formed at the walls, and a low pressure area at the channel center, that drafts sucks air into the air intake;
the blades-spirals, mounted at an angle to the axis of the channel, capture and throw the air pressed to the walls in the direction of movement (towards the exhaust nozzle) at a velocity higher than the velocity of the inlet airflow;
provide transonic velocity of the airflow in the channel's narrowing.

The air speed through the inlet cone will increase faster when the blades-spirals accelerating airflow are available, than without such blades-spirals (with a sufficient speed of inlet cone rotation).

With supersonic (hypersonic) velocities of flying apparatus, a mechanism of supersonic (hypersonic) ramjet with a direct-flow annular combustion chamber are implemented. See for example: U.S. Pat. No. RU2487256 C2—METHOD OF DETONATION HYDROGEN COMBUSTION IN STATIONARY SUPERSONIC FLOW. Author: Tunik J. V. (RU).

RTDE's operation modes depend on the flight conditions.

Starting operation of the engine is the beginning of rotation of the cones that occurs on a motionless flying apparatus (the relative airflow speed is zero) from a battery or an external source. The inlet cone, when rotating forces air into the channel, and so increases pressure in the combustion chamber, that is, it works as a turbojet engine's compressor. Simultaneously, accelerating the flow along the channel, the inlet cone forms a jet thrust. That is, at the start and with subsonic flight it works as a fan of the turbofan jet.

Fuel supply to the central channel is provided in the narrow middle section of the channel—the “mixing area” having a conical expansion along the central channel in front of the exhaust section (nozzle) with an opening towards the exhaust section, through tilting fuel channels of a centripetal pump, attached firmly to the exhaust section (nozzle), tangential to the surface of the channel and at an angle in the axis direction of the central channel in front of each blade-spiral of the exit cone, which has a surface bend at this point, which forms a twisting of the fuel jet along a small radius.

Thus, in the mixing area, along the perimeter of the central stream (channel) a layer of twisted fuel jets is formed, that resembles a round rolling bearing (consisting of gas jets), creating a fuel-air mixture at the points of contact with the airflow of the central part of the channel.

After the mixing, ignition of the mixture is carried out. For this purpose, electrodes are made around the central axis of the channel (for example, on/between the blades), high voltage is applied between them (pulsed high-voltage discharges are generated), igniting the mixture in the rotating jets in a detonation mode.

The mixing area and the combustion chamber are designed in the single cone expansion so that the front of detonation combustion and shock waves, formed therein near blades, would be directed along the exhaust section in the direction of its output in the form of spiral-shaped blast waves, rotating around the axis of the central channel.

Rotating jets, appeared after the detonation combustion of fuel, embrace the airflow of the central channel along the perimeter, moving along the exhaust section, expand and accelerate, carrying away the airflow of the central channel.

The shape of the blades in the exhaust section and the location of the outputs of the nozzle-inclined fuel channels of the centripetal pump are formed so that the rotating and expanding (after combustion) jets along the perimeter of the exhaust section apply pressure onto the cone's blades on one side (centers of rotation of the jets are shifted to the blades on one side), rotating the cone (nozzle) in a desired direction.

Speed of the rotation of the turbine is regulated by the amount, temperature and pressure of fuel being supplied, the system of its burning, and also by electromagnetic means.

In flight, the rotation of the inlet cone is provided by rotation of the exhaust section (turbine) through a gear box, or through an electric drive, or as a single combined rotating part.

With a rigid connection of the inlet cone and the exhaust section as a single integral part, the gear ratio between the cones will always be equal to 1.

When the inlet cone and the exhaust section are connected via a gear box, the gear ratio may differ from 1.

When the inlet cone and the exhaust section are connected via an electric drive, the gear ratio between the cones can be made variable—when the inlet cone (that is not rigidly attached to the exhaust section) is made in the form of an armature of an independent electric motor with attached magnets, while the adjoining (in this place) part of the casing is made in the form of a stator of the independent electric motor, with fixed electromagnetic coils, that are powered through a control system by a battery or a turbine.

At a supersonic velocity of the flying apparatus, at the leading edge of the air intake, in front of the blades of the inlet cone, a conical (tapering) compression shock is formed, that is directed inwards from the perimeter to the center of the channel.

The geometry of the air intake is arranged in such a way, so that, at a low supersonic velocity of the flying apparatus (and considering that the compression shock's angle depends on this velocity), this compression shock does not touch the inlet cone's blades.

At the supersonic velocity of the flying apparatus behind the compression shock formed at the leading edge, in the region adjacent to the inlet cone surface, the flow speed is subsonic. From this subsonic region, the spinning inlet cone pumping air will decrease the pressure and, correspondingly, the compression shock's angle.

That is, because of rotation of the inlet cone, the compression shock will be pressed to the inner surface of the inlet cone, and the vertex of the formed compression shock cone will shift into the depth of the channel.

The flow with a transonic velocity in the narrow part of the channel, accelerating in the de Laval nozzle up to supersonic velocity, will develop thrust as in a ramjet engine, and, taking into account the presence of the turbine, as a turbojet engine.

If at the supersonic velocity of the flying apparatus, the flow speed in the narrow part of the channel remains supersonic, increasing in the exhaust section (nozzle), then a hypersonic ramjet mode will be created regardless of the presence or absence of blades in the cones at the input and output of the engine.

However, the absence of blades in the exhaust section will not permit energy generation and use of this energy for spinning the inlet cone (fan/compressor) at a low flight velocity.

The rotating exhaust section can be used as an armature of an electric generator if permanent magnets are attached to the outer section of the rotating cone, and the windings of immovable electromagnetic coils are attached to the inner surface of the adjacent section of the housing used as a stator.

When the armature rotates, electric current will be induced in stator's windings. The generated electricity can be used to ignite burning mixture in the combustion chamber, supply magnetic bearings (if any are used), rotate the inlet cone, and supply the onboard equipment of the flying apparatus and charge of on-board batteries.

### BRIEF DESCRIPTION OF DRAWINGS OF THE INVENTION

All elements in the drawings are shown without certain scale and proportions and are reflected in sectional views of parts of the inventive RTDE (Ram-jet and turbo-jet detonation engine), that form a single integral item.

FIG. 1—Cross section along the principal plane of symmetry with unfolded blades-spirals and unfolded fuel channels of the centripetal pump:
1—rotating inlet cone (fan/compressor);
2—unfolded blades-spirals of the inlet cone (fan/compressor);
3—rotating exhaust section (turbine/nozzle);
4—unfolded blades-spirals of the exhaust section (turbine/nozzle);
5—fixed part of the centripetal pump —fuel storage;
6—nozzles (vents) of fuel supply to the fuel storage;
7—fuel channel of the centripetal pump;
8—rotating part of the centripetal pump;
9—conical expansion of the channel—mixing area and chamber/combustion area;
10—airstream/approaching flow.
Cross sections: A-A, B-B, C-C, D-D—cross-sectional view perpendicular to the channel.

Cross Sections—view along the channel:

FIG. 2 depicts cross-sectional view of the rotating inlet cone (fan/compressor) —A-A:
11—rotation direction of RTDE's parts;
12—rotation direction of air flow in the central channel.

FIG. 3 depicts a cross-sectional view of a rotating middle part extended up to the centripetal pump—B-B.

FIG. 4 depicts a cross-sectional view of the centripetal pump with unfolded fuel channels—C-C: 13—rotation direction of rotating fuel-air mixture jets.

FIG. 5 depicts a cross-sectional view of the rotating exhaust section (turbine/nozzle) —D-D: 14—the direction of rotation of the rotating jets of the combustion products.

### THE PREFERRED EMBODIMENTS OF THE INVENTION.

The Simplest Embodiment (FIG. 1).

All the rotating elements during the production are integrated into a single integrated detail, the inner blades of which, having a helix form, are screwed in one direction (clock-wise or counter clock-wise), while changing by its form, height and spacing, extending from the beginning of the inlet cone and to the end of the exhaust section.

The blades have minimal height in the narrow middle section of the channel (possibly, the height can be zero—the absence of the blades in the portion of the maximum conversion of the channel).

An inlet cone (fan/compressor) 1 (FIG. 1) with blades-spirals is configured to:

a) at subsonic velocity of the FA,
provide the rotation of the input (countercurrent) airstream 10 (FIG. 1) in the center of the channel in the direction 12 (FIG. 2) by rotating the cone 1 in the direction 11, wherein the air pressed by the centrifugal force to the inner perimeter of the inlet cone, thus, increasing the pressure near the blades 2;
accelerate the wall air flow along the channel and discharge the air in the mixing portion, and, furthermore, in the combustion chamber, while functioning as a fan and a compressor;
provide the near-sonic velocity of the airflow in a conversion (narrowing part) of the channel;

b) at supersonic velocity of the FA:
drag the vertex of the compression shock's cone, which is formed in the front edge of the air inlet, inside the channel, providing more even (laminar) air movement in the inlet.

The front edges of the spiral blades of the inlet cone 2 (FIG. 1.) must have cutoffs of outer angles, so that at a low supersonic velocity the conical compression shock, which starts at the front edge of the air inlet and is directed inside the channel, does not touch them.

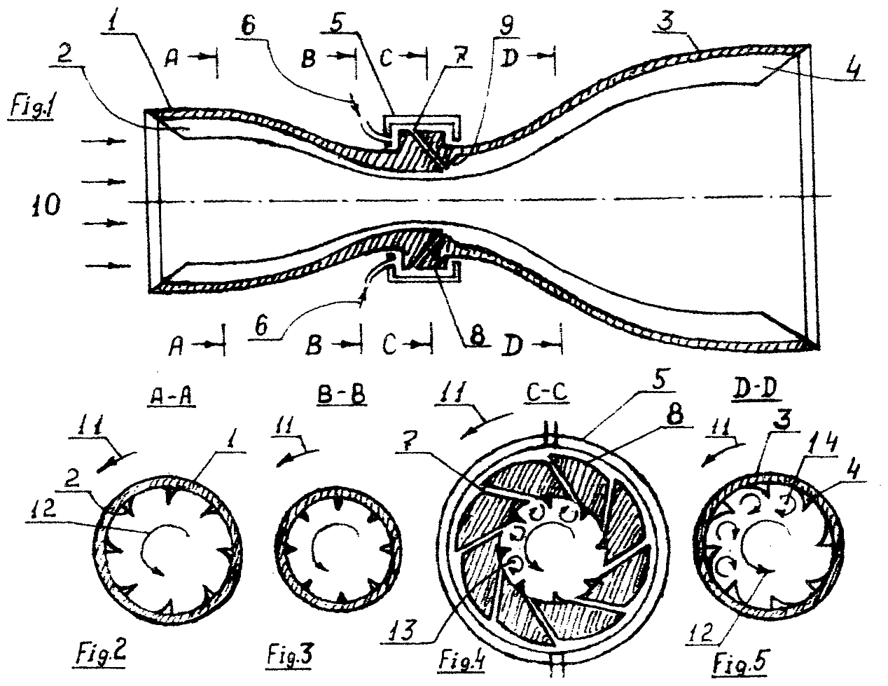

At the subsonic motion of the approach flow/airstream 10 (FIG. 1.) along the narrowing inlet cone 1 (FIG. 1), the velocity in the channel gradually increases, and, subsequently, the tilt angle of the blades towards the axis of the engine (channel) must decrease while the helix pitch (the spiral's step) increases. Thus, the helix pitch must be maximum in the narrowest middle portion of the central channel (FIG. 3), while the spiral must be “stretched” to the limit, and the height of the spiral blades must be minimal/(close to zero).

A fuel injection device (centripetal pump) 8 (FIG. 1) is configured to inject the fuel from an immovable part of the fuel system, associated with the FA's body, to a rotating annular mixing part.

The rotating part of the centripetal fuel injection pump 8, having the fuel delivery ducts 7, is rigidly connected (i.e. constitutes a single integral unit) with the turbine 3 (FIG. 1), while the immovable round external part of the pump body 5, which simultaneously acts as a fuel storage unit, is rigidly connected to the immovable outer casing of the engine.

The immovable round external part of the pump 5 (fuel storage unit) is a U-shaped rotating object (or V-shaped or alike), having an open portion facing the axis of rotation.

The fuel is injected into the fuel storage unit by the apertures (ducts) 6 situated sidewise, located at some distance from the inner “bottom” of the U-profile from several (opposite) sides of this body 5.

During the spinning of the rotating inner part of the pump, the injected fuel, which is dragged (captured) by the rotation, is depressed by the centrifugal force to the inner immovable U-shaped “bottom” (of the profile) of the fuel storage unit forming an even layer.

The length of a duct between the inner “bottom” of the fuel storage unit and the apertures for fuel injection into it must exceed the distance between the “bottom” of the fuel storage unit and the rotating part of the pump.

The amount of the injected fuel must be such that, during the rotation of the central (rotating) part of the pump, the level of fuel reached (immersed) the inputs of the fuel channels of the inner rotating part of the centripetal pump, but also did not reach (did not fill) the apertures for fuel injection. This mode is designed to inject the liquid fuel into the combustion chamber.

The fuel is injected by the inlets of the fuel channels, facing in the same direction as the direction of the rotation of the central part of the centripetal pump, and is injected to the section mixing fuel and air, located along the perimeter (around) of the narrow part of the central channel of the engine.

The direct-flow combustion chamber may require more combustible gas fuel at the hypersonic (supersonic) velocity of the FA.

In order to inject the gas fuel (vapor) into the combustion chamber, the amount of the fuel, injected into the fuel storage unit, is adjusted in such manner that the inlets of the fuel channels of the rotating part of the pump (during its rotation) would not reach the level of the liquid fuel, which is depressed by the centrifugal force to the “bottom” of the fuel storage unit (that would be located above it), and the fuel channels would receive only vapor of the fuel.

The electrical heating elements, which regulate/increase the temperature of the fuel in the fuel storage unit, are attached to the body of the resting fuel storage unit on the exterior side in order to provide intensive evaporation of the fuel, increase of the temperature and pressure of the fuel vapor in the fuel storage unit, or, if necessary, inject the hot liquid fuel into the combustion chamber.

The mixing portion of fuel with air 9 (FIG. 1.) is designed to create a combustible fuel-air mixture by creating along the perimeter (around) of the central part of the flow of the rotating airflows (resembling the rotating roller in the roller bearing, but consisting of gas jets)—section C-C (FIG. 4).

The form of the blades on this portion is made in such a way, that the streams twirl at a small radius 13.

The velocity of the fuel stream in the fuel channels of the centripetal pump and, subsequently, the velocity of outflow of fuel in the central channel will be subsonic.

The combustion chamber (portion) with detonation burning (combustion) 9 (FIG. 1) is configured for impulse detonation, burning the combustion mixture, while its surface acts as a reflective surface during the detonation burning.

The blades-spirals on this portion are located so that that one of their sides is approximated to one rotating stream so (every blade is associated with its own stream) that the pressure of the flow during the detonation burning on this (“own”) blade is greater than on the more distant blade from the other side of the flow.

The direction (the angle of location) of the reflective surfaces of the blades is made so that, during the detonation burning, the reflected wave is directed along the channel of the spiral.

Thus, the tangential component of the pressure on the reflecting surface during the detonation burning rotates the exhaust section (nozzle), and the component of the pressure creates the exhaust thrust.

The mode of impulse high-voltage burning is chosen on the basis of durability and possibility of oxygen-hydrocarbon mixture burning.

The pulse ratio and the periodicity of the high-voltage impulses of the detonation burning of the burning mixture are chosen so that with them the stream of the burning mixture, while rotating, could pass from the beginning to the end of the cone extension of the rotating channel after the mixing portion (mixing portion—chamber/combustion portion).

The frequency of the burning impulses which depends on the velocity of rotation of the burning chamber and the amount of blades-spirals will be high. This will provide for high and constant average engine thrust.

The blades-spirals will have a gap between the mixing portion and the chamber/burning portion.

The exhaust section (nozzle/turbine) 3 (FIG. 1.) is configured to:
create the engine thrust by forming the supersonic reactive jet flow; and
provide the rotation of the nozzle with the use of tangential component of the pressure of the flow.

The rotating and extending flows 14 (FIG. 5.) after burning on the perimeter around the central flow 12 provide linear pressure on the blades 4, as in the combustion chamber, while providing additional tangential force which rotates the nozzle 3 in the direction 11.

The engine thrust and the rotation of the nozzle are provided by the accumulated linear and tangential forces inside the cone-like combustion chamber (during the detonation burning) and in the output cone (during the supersonic exit of the jet flow).

The inlet cone is made in the form of an electric motor so that it could be swirled with the use of vehicle-borne batteries or an external source (during the start).

The exhaust section is made in the form of an electrical generator so that it could provide burning of the air-fuel mixture, charging of magnetic bearings (if provided), charging of vehicle-borne batteries and vehicle-borne equipment of the FA.

The rotation of the inlet cone during the flight is provided by rotation of the exhaust conical section (nozzle/turbine), which is rigidly connected to the inlet cone.

The electrical elements (magnets, magnetic coil), located on the rotating parts of the engine, are made by planar technology on their external surfaces in order to minimize their thickness and weight.

The bearings (frictionless or magnetic), which are located at the external surfaces of the rotating parts, are used as devices that provide for mounting the rotating parts of the engine on the immovable outer case.

### INDUSTRIAL APPLICABILITY

The straight-flow turbo-jet engine is configured as the engine of military/civilian apparatus which has horizontal takeoff/landing and long flight with the possibility to change/mix the velocity between subsonic and hypersonic velocity.

Apart from that, the straight-flow turbo-jet engine can be used as an independent stationary/mobile electric generator or a pump configured to pump air at a high-velocity (for example, in wind tunnels).

1. A ram-jet and turbo-jet detonation engine comprising an inlet part, including a fan and a compressor, a middle part, which includes a fuel injection device to the mixing portion, the mixing portion of the fuel and air, the burning system of the air-and-fuel mixture and combustion chamber, and the exhaust part, which comprises a turbine and exhaust nozzle, and the system of fuel ingestion, the device which provides the attachment to the outer case, and the engine control system, which is characterized by the fact that the inlet part and exhaust part are made in the form of axially symmetric round hollow rotating cones connected between each other in the narrow middle part by its narrow parts, which have blades, installed on the inner parts of the cones, that also do not block completely the central part of the channel and form the spirals, spinning around the common central axis of the channel, wherein the inlet cone fulfills the function of the fan/compressor, and the exhaust section with blades has a turbine and exhaust nozzle, wherein the middle part and exhaust section are integrated into one unified detail, the fuel injection device, which provides fuel injection into the mixing portion, is made in the form of a centripetal pump, while the burning system provides the burning of the air-and-fuel mixture in the detonation mode by creating short high-voltage impulses, wherein the rotating parts of the engine are fixed to the external part of the outer case with the use of the bearings installed on the external surfaces of the rotating parts.

2. The ram-jet and turbo-jet detonation engine according to claim 1, wherein the flow tube of the engine is made in the form of a de Laval nozzle having the blades-spirals.

3. The ram-jet and turbo-jet detonation engine according to claim 1, wherein the inlet cone, middle part and exhaust section are made in the form of a single integral rotating detail.

4. The ram-jet and turbo-jet detonation engine according to claim 1, wherein the inlet cone is connected with the middle part by the reduction gear.

5. The ram-jet and turbo-jet detonation engine according to claim 1, wherein the mixing portion and combustion chamber are made in the form of the single round cone expansion of the central channel located in front of the exhaust section having an opening to the side of the exhaust section, while the blades are located near every fuel injection nozzle, rotating every flow of the fuel in accordance with a small radius.

6. The ram-jet and turbo-jet detonation engine according to claim 1, wherein the form, height and spacing of the blades-spirals changes along the axis of the channel.

7. The ram-jet and turbo-jet detonation engine according to claim 1, wherein the exhaust section of adjacent portion of outer case are made as an electric generator, where the rotating exhaust section with magnets attached is used as an armature, and the function of the stator is fulfilled by the adjacent portion of the outer case which has immobile magnetic coils attached to it.

8. The ram-jet and turbo-jet detonation engine according to claim 1, wherein the inlet cone and the adjacent portion of outer case are made as the electric motor, wherein the rotating inlet cone with permanent magnets attached is used as an armature, and the function of the stator is fulfilled by the adjacent portion of the outer case which has immobile magnetic coils attached to it.

9. The ram-jet and turbo-jet detonation engine according to claim 7, wherein the power, produced by the electric generator, is used for charging of the engine itself, airborne equipment and charging of the accumulators.

10. The ram-jet and turbo-jet detonation engine according to claims 7, wherein the electronic elements (magnets, magnetic coils) which are located at the rotating parts of the engine are made by a planar method on their exterior surfaces.

11. The ram-jet and turbo-jet detonation engine according to claim 8, wherein the electronic elements (magnets, magnetic coils) which are located at the rotating parts of the engine are made by a planar method on their exterior surfaces.
